(19) United States
(12) Patent Application Publication
(10) Pub. No.: US 2010/0200177 A1
(43) Pub. Date: Aug. 12, 2010

(54) MODEL CURTAIN DRIVING APPARATUS

(76) Inventor: Byung Doo Kim, Seoul (KR)

Correspondence Address: HYUN JONG PARK;Park & Associates IP Law LLC, 265 Bic Drive, Suite 106, Milford, CT, 06461, US

(21) Appl. No.: 11/916,205

(22) PCT Filed: May 29, 2006
(86) PCT No.: PCT/KR2006/002039

§ 371 Date: Nov. 30, 2007

(30) Foreign Application Priority Data
May 31, 2005 (KR) 10-2005-0046030

(51) Int. Cl. A47H 5/02; H02P 1/58

(52) U.S. Cl. 160/331; 318/5

(57) ABSTRACT

Provided is a contour curtain driving apparatus which independently ascends and descends a contour curtain which is divided into a number of sub-curtains using a motor, respectively. The contour curtain driving apparatus includes a selector having a selection switch for selecting a driving mode of the contour curtain, an automatic controller controlling the location of the entire contour curtain according to the input of mode switches, a manual controller controlling the location of the contour curtain according to the input of a jog switch, and limit switches which are installed to mechanically change the position set by the automatic controller. Accordingly, the contour curtain is set up in various shapes. The contour curtain driving apparatus can be run immediately after recovery of the circuit out of order due to a momentary power failure or an overload trip. Maintenance and repair can be economically performed since the manipulation limit switches stand close together.

### CROSS REFERENCE TO RELATED APPLICATIONS

This application claims priority from PCT Application PCT/KR2006/002039 filed on 29 May 2006, which application claimed priority to Korean Application 10-2005-00460030 filed 31 May 2005. The PCT/KR2006/002039 and the 10-2005-00460030 applications are incorporated by reference herein, in their entirety, for all purposes.

### BACKGROUND AND SUMMARY

The present invention relates to a contour curtain driving apparatus, and more particularly to a contour curtain driving apparatus which can be applied in a contour curtain which is a kind of a performance place stage act-drop, a ceiling opening and closing switchgear for a dome stadium, a glass green house opening and closing switchgear, a marine farming area covering apparatus, etc.

In the case of a stage facility at a performance place, a conventional contour curtain which is a kind of a stage act-drop is used only at the beginning and end time of the stage. However, it is in a trend that such a contour curtain is being gradually used as various forms to fit with a performance characteristic. FIG. 1 is a diagrammatic view showing various modes of the drive of a typical contour curtain. As shown in FIG. 1, modes 0 and 4 may be changed into modes 1 through 3. Such a necessity of changing a contour curtain of the modes 0 and 4 into the mode 1 through 3 increases.

FIG. 2 is a configurational diagram of an external form of a control panel which is used for the conventional contour curtain driving apparatus, and FIG. 3 is a sequence circuit diagram which is comprised in the contour curtain driving apparatus of FIG. 2.

In FIGS. 2 and 3, T1 through T4 are timer relays connected to first through fourth motors, respectively. T1 determines a rise-up operating time of the first motor, T2 determines a rise-up operating time of the second motor, T3 determines a rise-up operating time of the fourth motor, and T4 determines a rise-up operating time of the third motor. In FIG. 1, the innermost contour curtain is connected to the first motor, and the other contour curtains which are positioned outwards from the innermost contour curtain are connected to the second through fourth motors, respectively.

In FIG. 3, a reference character MU denotes a magnetic contactor for rise-up operating of a motor, and a reference character MD denotes a magnetic contactor for a fall operation of a motor, in which a figure attached after the MU or MD indicates a motor number. Reference characters FLTLs denote a rising termination limit switch, respectively, and reference characters FDLs denote a lowering termination limit switch, respectively, in which a figure attached before the FUL or FDL indicates a motor number. Reference characters CUXs respectively denote an upward control relay, reference characters CDXs respectively denote a downward control relay, and a reference character STPX denotes a pause control relay. A reference character RE denotes an overcurrent trip relay, and a reference character H denotes a manual manipulation selection relay. Reference characters UXs denote a relay which operates the MU and thus enables the motor to be driven to make the contour curtain rise up, respectively, and reference characters DXs denote a relay which operates the MD and thus enables the motor to be driven to make the contour curtain fall down, respectively. In addition, reference characters EOCRs denote a relay which makes all corresponding motors stop when overcurrent is generated, respectively.

A major principle of driving a contour curtain in a conventional contour curtain driving system is based on limited time contact timer relays T1, T2, T3, and T4. Otherwise, in order to drive a contour curtain, a conventional contour curtain driving system includes a driving circuit in association with a PLC (Programmable Logic Control) high-speed counter program of an encoder, a PG (Pulse Generator), etc. In this case, in view of the characteristics of a motor stop condition circuit using an electrical signal, if the contour is changed from a contour form to another, the contour form should be necessarily returned to an original contour form, that is, an initial state, and then a desired contour form should be selected. As a result, the conventional contour curtain driving system has a limitation that cannot be used for a change in scenes during a public performance. Moreover, although the drive motor is stopped due to a momentary power failure or an overload, and then an operation is reopened during operation, the conventional contour curtain driving apparatus should be returned to the initial contour form and then a newly desired contour form should be selected. Likewise, the conventional contour curtain driving apparatus has been limited and thus restrictively used only at the beginning and end time of a public performance.

To solve the above problems, it is an object of the present invention to provide a contour curtain driving apparatus which is simplified having no timer relay, encoder, and pulse generator and includes a variety of functions to them be changed into an economical facility, in which any of operating points are set in respective contour sub-curtains of a contour curtain having a number of contour sub-curtains and thus a contour form needed at any operating point can be quickly produced. To accomplish the above object of the present invention, according to an aspect of the present invention, there is provided a contour curtain driving apparatus which independently ascends and descends a contour curtain which is divided into a number of sub-curtains using a motor, respectively, the contour curtain driving apparatus comprising: a selector having a selection switch for selecting a driving mode of the contour curtain; an automatic controller which is connected to one end of the selector in a circuitry manner, controlling the location of the entire contour curtain according to the input of mode switches; a manual controller which is connected to the other end of the selector in a circuitry manner, controlling the location of the contour curtain according to the input of a jog switch, and limit switches which are installed to mechanically change the position set by the automatic controller or the manual controller. Here, the contour curtain driving apparatus further comprises a DC (Direct Current) diode so that the affect of one side mode at each mode switch acts restrictively on the other side mode thereof. Moreover, the drive of the motor according to the input conditions of the selector, the automatic controller, the manual controller, and the limit switches is performed by a PLC (Programmable Logic Control) unit.

In this way, the present invention implements the contour curtain driving system which enables a thin cover or curtain installed at the stage or the like to be movable and changed in a spatial shape, to thus accomplish the object of having and improving the flexibility, speed, and convenience which are manually or automatically controlled.

### DESCRIPTION OF THE DRAWINGS

FIG. 1 is a diagrammatic view illustrating various modes of the drive of a typical contour curtain;

FIG. 2 is a configurational diagram of an external form of a control panel which is used for the conventional contour curtain driving apparatus;

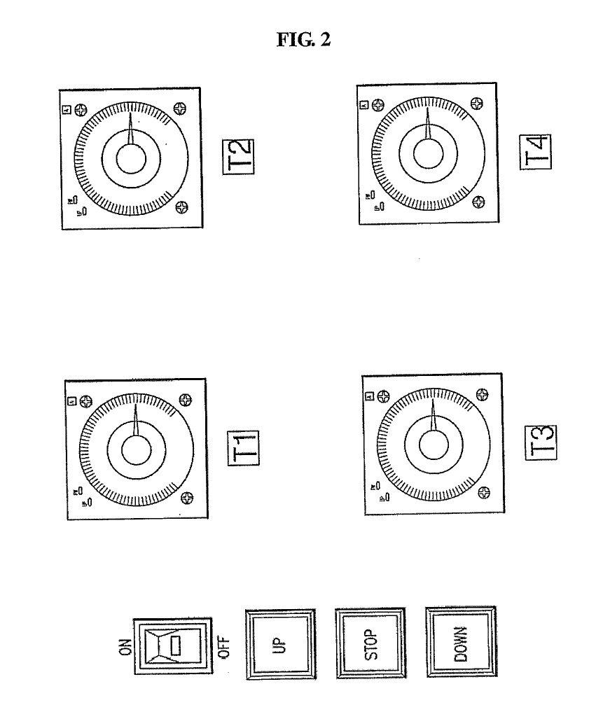

FIG. 3 is a sequence circuit diagram which is comprised in the contour curtain driving apparatus of FIG. 2;

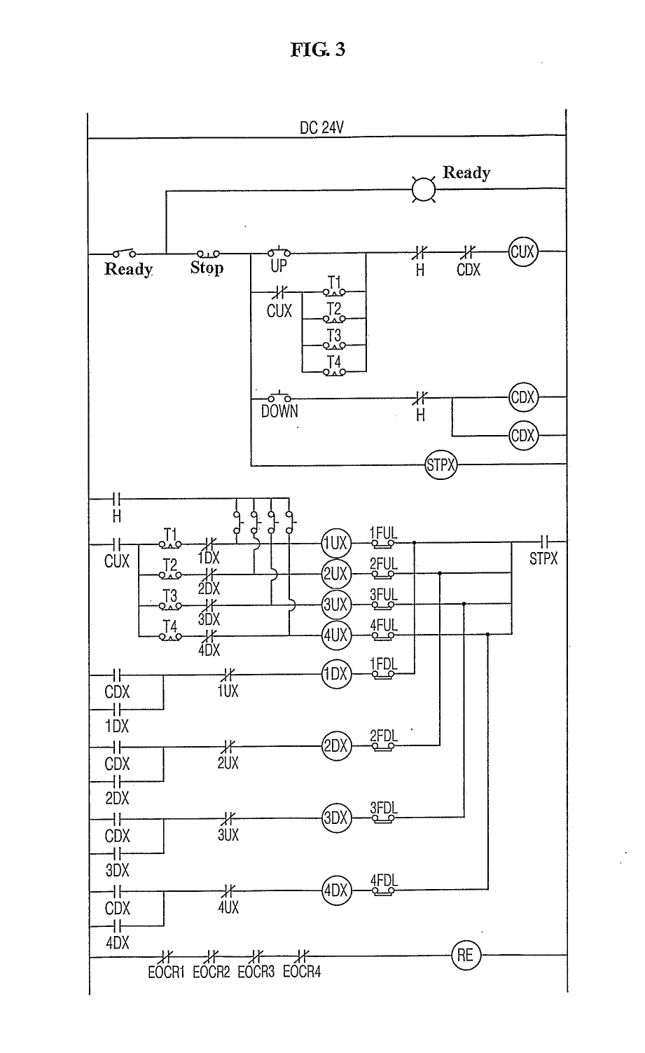

FIG. 4 is a configurational diagram of an external form of a control panel which is used for a contour curtain driving apparatus according to the present invention;

FIG. 5 is a sequence circuit diagram which is comprised in a contour curtain driving apparatus according to an embodiment of the present invention;

FIG. 6 is a sequence circuit diagram which illustrates parts of a contour curtain driving apparatus according to a modified embodiment of the present invention;

FIG. 7 is a ladder diagram illustrating parts of a contour curtain driving apparatus according to another embodiment of the present invention; and

FIG. 8 is a perspective view of a variable limit switch which is applied in the present invention.

### DETAILED DESCRIPTION

Hereinbelow, a contour curtain driving apparatus according to preferred embodiments of the present invention will be described with reference to the accompanying drawings.

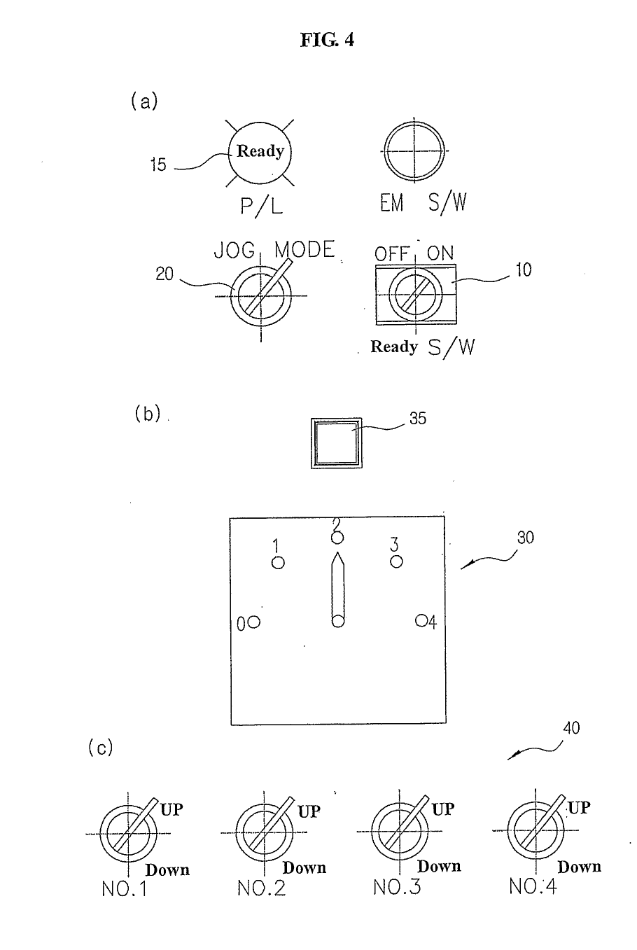

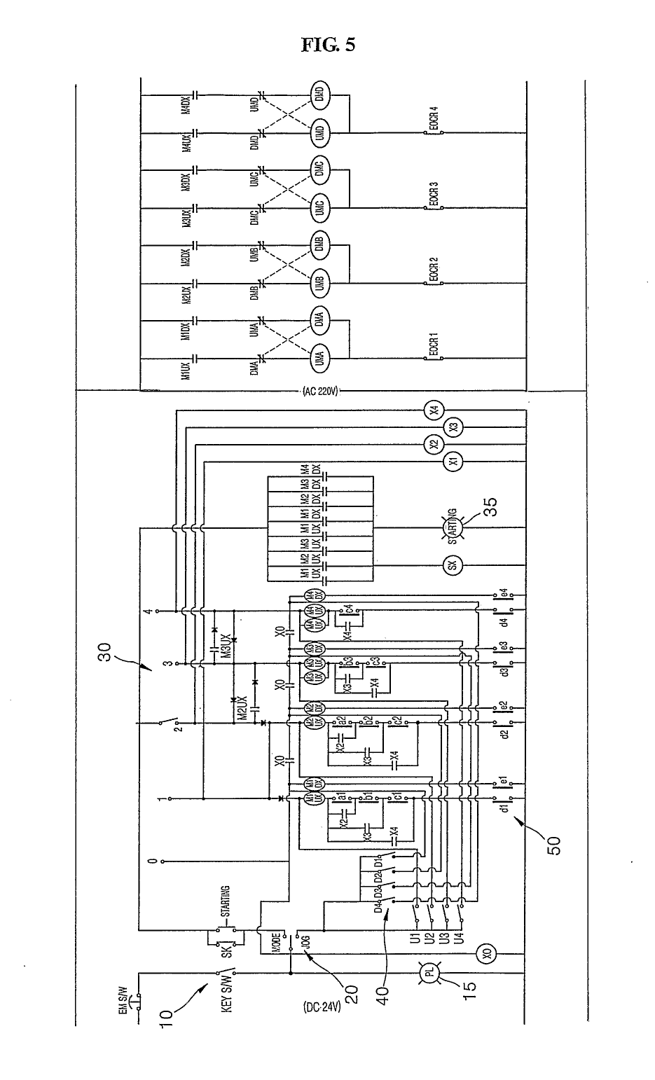

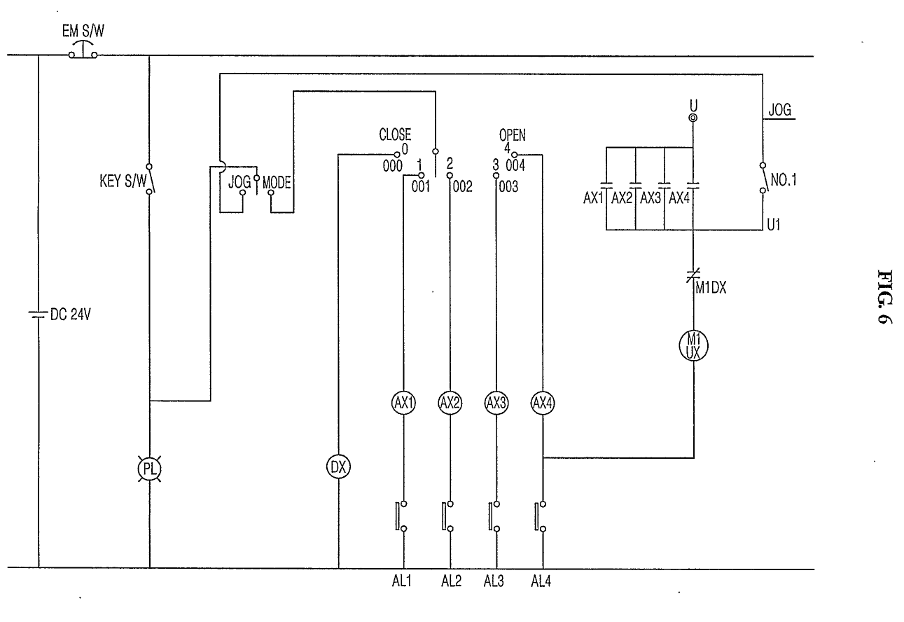

FIG. 4 is a configurational diagram of an external form of a control panel which is used for a contour curtain driving apparatus according to the present invention. FIG. 5 is a sequence circuit diagram which is comprised in a contour curtain driving apparatus according to an embodiment of present invention. FIG. 6 is a sequence circuit diagram which illustrates parts of a contour curtain driving apparatus according to a modified embodiment of present invention. Referring to FIGS. 4 through 6, a contour curtain driving apparatus according to one embodiment of the present invention independently ascends and descends a contour curtain which is divided into a number of sub-curtains using a motor, respectively. The structure of dividing the contour curtain and the configuration of the contour curtain driving apparatus having the motors are the same as those of the conventional contour curtain driving apparatus. Accordingly, the detailed description thereof will be omitted.

The contour curtain driving apparatus according to an embodiment of the present invention includes a selection switch 20 selecting a driving mode of a contour curtain. The selection switch 20 is connected to a ready switch 10 in order to select two kinds of modes which will be described later. Once the ready switch 10 is turned on, electric power is applied to a contour curtain driving circuit located at one side of the selection switch 20. Accordingly, the contour curtain driving circuit becomes a standby state which is ready to operate. In the case that four motors M are used, they are driven by eight magnetic contactors. In an embodiment, the eight magnetic contactors are controlled by a control relay whose coil voltage is AC 220V and are controlled by control relays whose operating voltage is DC 24V, and a DC (Direct Current) diode. Other relays with differing operating voltages may be used without departing from the scope hereof.

In FIG. 5, a reference character UMA denotes a power relay for a rise-up operation of a first motor, a reference character DMA denotes a power relay for a fall operation of the first motor, UMB denotes a power relay for a rise-up operation of a second motor, a reference character DMB denotes a power relay for a fall operation of the second motor, UMC denotes a power relay for a rise-up operation of a third motor, a reference character DMC denotes a power relay for a fall operation of the third motor, UMD denotes a power relay for a rise-up operation of a fourth motor, and a reference character DMD denotes a power relay for a fall operation of the fourth motor.

In FIG. 4, a reference numeral 15 denotes a ready lamp which operates with the ready switch 10, and a reference numeral 35 denotes a starting lamp which is turned on and off according to operation of one motor M. An emergency (EM) switch is a switch for inputting an emergency shut-down. In addition, an automatic controller controlling the location of the entire contour curtain according to the input of a mode switch 30 is connected to one side of a selector including the selection switch 20 in a circuitry manner, and a manual controller controlling the location of the contour curtain according to the input of a jog switch 40 is connected to the other side of the selector including the selection switch 20 in a circuitry manner.

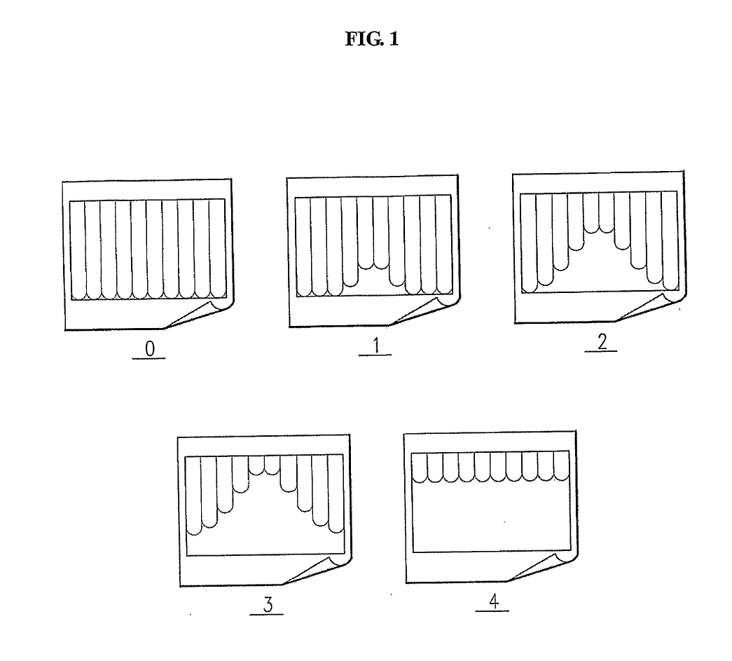

In the mode switch 30, the modes 0 through 4 represent shapes of the entire contour curtain of FIG. 1. A reference character U in the jog switch 40 means the rise-up of the corresponding contour curtain, and a reference character D therein means the lowering of the corresponding contour curtain. The automatic controller and manual controller are connected so that a DC power is applied to a control relay. In the control relay, M1UX drives UMA, M1DX drives DMA, M2UX drives UMB, M2DX drives DMB, M3UX drives UMC, M3DX drives DMC, M4UX drives LTMD, and M4DX drives DMD. Besides, SX self-holds a starting signal. Control DC relays X0, X1, X2, X3, and X4 are turned on a respective step of the automatic control, and is used at the contacts in a self-hold circuit of the automatic controller.

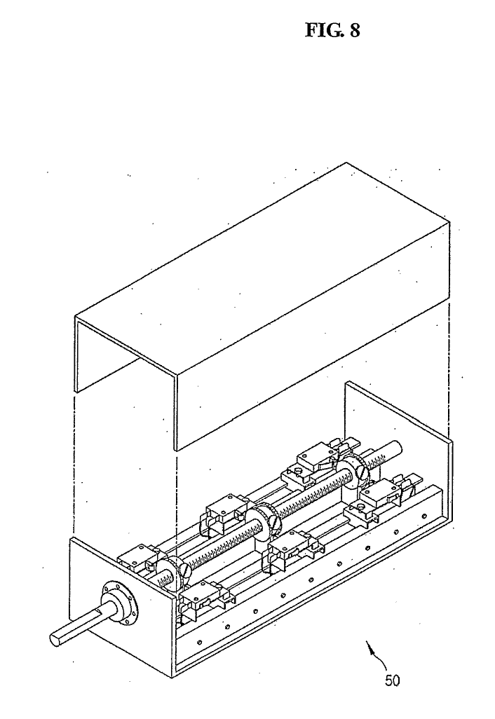

Also, the contour curtain driving apparatus according to the present invention includes a variable limit switch assembly 50 of FIG. 8 including limit switches which are installed to mechanically change the position set by the automatic controller or the manual controller. Four motors M include a dedicated variable limit switch assembly, respectively. Motor M1 includes contacts point a1, b1, c1, d1, and e1, motor M2 includes contacts point a2, b2, c2, d2, and e2, motor M3 includes contacts point a3, b3, c3, d3, and e3, and motor M4 includes contacts point a4, b4, c4, d4, and e4. Here, each motor M is controlled at five positions, but can be controlled in modified number. The term “variable” means that detection positions of respective switching elements in the limit switch 50 can be moved.

Here, it is possible that the mode switch 30 further includes a DC diode so that the effect of one mode of the mode switch 30 restrictively acts on the other mode thereof. In FIG. 5, a DC diode is connected between the mode switches 30. Meanwhile, in FIG. 6, the automatic controller is separated from the manual controller in order to exclude the DC diode between the mode switches 30. Both the cases of FIGS. 5 and 6 have the differences in the modes constituting a circuit but perform the same operation and function.

In FIG. 5, the motors M can be driven in one direction of a forward or reverse direction, to arbitrarily select a desired contour sub-curtain and to thus change the contour curtain directly from one form to another. Accordingly, use of the contour curtain driving apparatus according to the present invention is not limited to the beginning and end time of a public performance but may be used for a change in scenes during a public performance, in a variety of forms. Additionally, because the position value of the contour curtain can be mechanically maintained even in the case of an accident including a power failure, an overload trip, etc., a change in shape of the contour curtain can be continued in the previously advancing direction immediately after the restoration of power.

The configuration of FIG. 6 is substantially same as that of FIG. 5, but only denotation of the elements of the former is different from that of the latter. Thus, the description of the circuit configuration will be omitted. The variable limit switches 50 are used for the first motor relay contacts AL1 through AL4, and then control relays are installed in correspondence to an operating point of the variable form limit switches 50, respectively. In this case, the maintenance becomes convenient. As described above, since the contour curtain driving apparatus according to the present invention does not use the limited time contacts of the timer relays which is the conventional driving principle but uses the mechanical variable limit switches 50, users can easily produce various contour forms according to various situations.

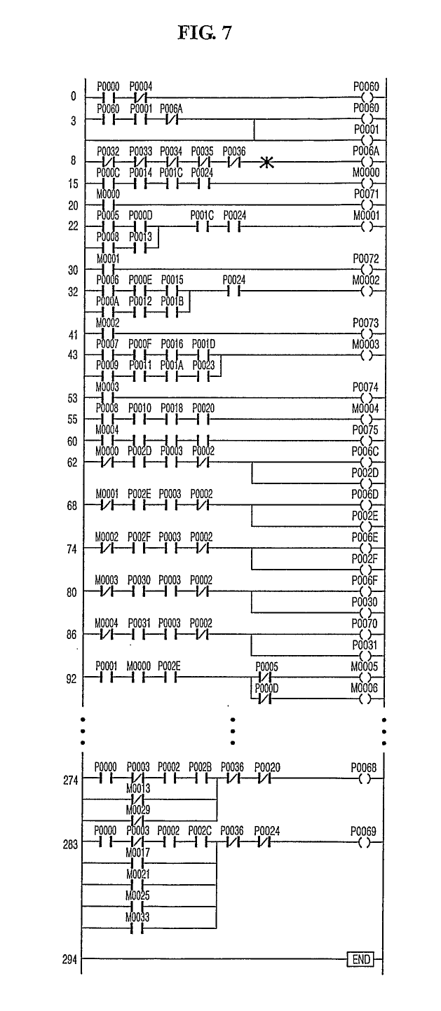

FIG. 7 is a ladder diagram illustrating parts of a contour curtain driving apparatus according to another embodiment of the present invention. FIG. 7 illustrates a part of the circuit. However, according to the input conditions of the selector, the automatic controller, the manual controller, and the limit switches 50, the configuration where the drives of the motors M are performed by a PLC is also possible. The contour form selection utilizing the PLC is made through a PLC program with a PBL switch called a dimming switch. After the contour form has been selected, a starting PBL switch operates a corresponding motor according to the selected contour form. A completion confirmation lamp is turned on and a contour form picture is turned on, if the contour form selection confirmation lamp is turned on and thus the contour form operation completes. In a functional contour form system, it is possible to perform the contour change-over in the rising or lowering direction. This is because it is freely possible to make transfiguration of a contour by driving the motors in any of the forwarding or reversing direction, since the stop conditions are maintained as the mechanical position values using the variable limit switches 50 instead of the conventional PLC time pulses, during operation of the drive motors. Even at the time of the malfunction occurrence due to the momentary power failure or the overload, the mechanical position values are maintained. Accordingly, the contour transformation can be continuously manipulated after the recovery of the circuit.

Of course, in view of the flexible control, the PLC control circuit FIG. 7 is more advantageous than the relay sequence circuits of FIGS. 5 and 6. Further, a dedicated microcomputer (MICOM) circuit (not illustrated) is more advantageous than the PLC control. However, in the case that the number of input and output points is not so many, it is sufficient to control the motor circuit with the PLC control. As described above, since the contour curtain driving apparatus according to the present invention employs the variable limit switch assembly in correspondence to the motors in order to mechanically maintain the position values, it can be consistently repeatedly manipulated in any of both forward and reverse directions. Accordingly, the contour curtain driving apparatus according to the present invention can be used in a contour curtain system for a performance place stage facility, a ceiling cover system for a dome stadium, a glass green house opening and closing system, a marine farming area covering apparatus, etc., in which the contour curtain can be repeatedly stably established in various forms. Even though the circuit goes down due to the momentary power failure or the overload trip etc., the circuit can be continuously operated immediately after recovery of the circuit. Further, since the manipulated limit switches stand closely together, it is possible to economically perform the maintenance and repair.

The present invention has been described with respect to the particularly preferred embodiments of the electric circuit using only the variable limit switch assembly. However, the present invention is not limited to the above embodiments, and it is possible for one who has an ordinary skill in the art to make various modifications and variations. Thus, the protective scope of the present invention is not defined within the detailed description thereof but is defined by the claims to be described later. Further, the present invention can be applied to a glass green house opening and closing apparatus whose window curtains are automatically opened and closed according to the circumstantial change such as the external temperature a contour curtain system for a performance place stage facility, a ceiling cover system for a dome stadium, and a marine farming area covering apparatus.

1. A contour curtain driving apparatus comprising:
a contour curtain comprising two or more sub-curtains, wherein the sub-curtains are configured to be independently lowered and raised;
a motor;
a selector having a selection switch comprising an automatic position and a manual position for selecting a driving mode of the contour curtain;
an automatic controller circuit selected by the selection switch moved to the automatic position, wherein the automatic controller circuit is responsive to control the location of the contour curtain according to the input of mode switches;
a manual controller circuit selected by the selection switch moved to the manual position, wherein the manual controller circuit is responsive to control the location of the contour curtain according to the input of a jog switch; and
limit switches, wherein the limit switches are configured to establish and maintain a stop position for each sub-curtain.

2. The contour curtain driving apparatus according to claim 1, further comprising a DC (Direct Current) diode so that the affect of one side mode at each mode switch acts restrictively on the other side mode thereof.

3. The contour curtain driving apparatus according to claim 1, wherein the drive of the motor according to the input conditions of the selector, the automatic controller, the manual controller, and the limit switches is performed by a PLC (Programmable Logic Control) unit.
